(19) United States
(12) Patent Application Publication
(10) Pub. No.: US 2017/0259094 A1
(43) Pub. Date: Sep. 14, 2017

(54) Water Spraying Fan for Firefighting

(71) Applicant: Dennis Sibila, Cotopaxi, CO (US)

(72) Inventor: Dennis Sibila, Cotopaxi, CO (US)

(21) Appl. No.: 15/453,446

(22) Filed: Mar. 8, 2017

Related U.S. Application Data
(60) Provisional application No. 62/305,195, filed on Mar. 8, 2016.

(51) Int. Cl. A62C 31/00; B05B 15/08; B05B 7/00; A62C 31/28; A62C 99/00

(52) U.S. Cl. CPC A62C 31/00; A62C 31/28; A62C 99/0072; B05B 7/0075; B05B 7/0081; B05B 15/08

(57) ABSTRACT

A water spraying fan for firefighting. The water spraying fan includes a fan mechanism mounted onto a rotatable surface attached to a base. The fan mechanism has a plurality of fan blades connected to a power source and adapted to rotate quickly, creating a strong air flow when powered on. A cage encloses the fan blades and includes one or more circular manifolds secured to a front side and positioned concentric to the fan blade axis. The manifolds contain a plurality of nozzles that are configured to disperse a liquid, such as water. The manifolds are connected to a water source via a flow control box. When activated, water flows out of the nozzles and is carried across an extended distance via the water pressure and the strong air flow created by the fan mechanism. The water spraying fan can be rotated or tilted to achieve optimal positioning.

### CROSS REFERENCE TO RELATED APPLICATIONS

This application claims the benefit of U.S. Provisional Application No. 62/305,195 filed on Mar. 8, 2016. The above identified patent application is herein incorporated by reference in its entirety to provide continuity of disclosure.

### BACKGROUND OF THE INVENTION

The present invention relates to water dispensing devices. More specifically, the present invention relates to water dispending devices having their effective working distance increased by high pressure air flow in addition to the source water pressure.

Many firefighting methods include dousing flames using water to extinguish a fire. The pressure of the water flow, which can be controlled by widening or narrowing the size of the outlet from which it flows, can propel water across a particular distance. However, the maximum distance that is covered by this method is limited by the available water pressure, which can be limiting is certain circumstances. This is particularly true when using water sources that have limited pressure to begin with, such as reservoirs of water stored on a fire engine. Additionally, windy conditions can further exacerbate the desired result of having a constant spray of water reach a specific distance. In larger fires, such as forest fires, the distance that water can travel due to the water pressure can fall short, effectively limiting the advantages of a fire engine.

Furthermore, a hose requires a user or fireman to hold and aim the nozzle in order to properly direct the flow of water, potentially for extended periods of time. This can be tiring, leading to premature fatigue of firefighters. Accordingly, a device that can easily increase the working distance of a water source, as well as aim the resulting spray in an efficient and convenient manner, is desired.

### SUMMARY OF THE INVENTION

In view of the foregoing disadvantages inherent in the known types of water dispensing devices now present in the prior art, the present invention provides a water spraying fan wherein the same can be utilized for providing convenience for the user when engaging in firefighting activities. The present system comprises a water spraying fan having a fan mechanism mounted onto a rotatable surface attached to a base. The fan mechanism has a plurality of fan blades connected to a power source and adapted to rotate quickly, creating a strong air flow when powered on. A cage encloses the fan blades and includes one or more circular manifolds secured to a front side thereof, where the manifolds include a plurality of nozzles that are configured to disperse a liquid. The manifolds are connected to a water source via a flow control box. When activated, water flows out of the nozzles and is carried across an extended distance via the water pressure and the strong air flow created by the fan mechanism. The water spraying fan can be rotated or tilted to achieve optimal positioning.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the water spraying fan for firefighting.

FIG. 2 shows a side view of an embodiment of the spraying fan for firefighting.

FIG. 3 shows a close up view of the tilting mechanism of an alternative embodiment of the spraying fan for firefighting.

FIG. 4 shows a perspective view of the spraying fan for firefighting in use.

### DETAILED DESCRIPTION OF THE INVENTION

Reference is made herein to the attached drawings. Like reference numerals are used throughout the drawings to depict like or similar elements of the water spraying fan. The figures are intended for representative purposes only and should not be considered to be limiting in any respect.

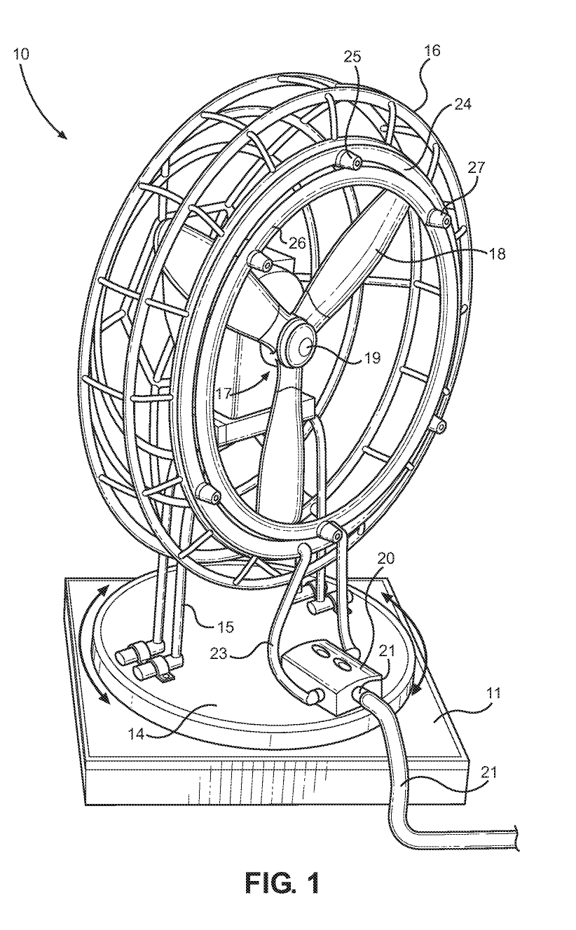

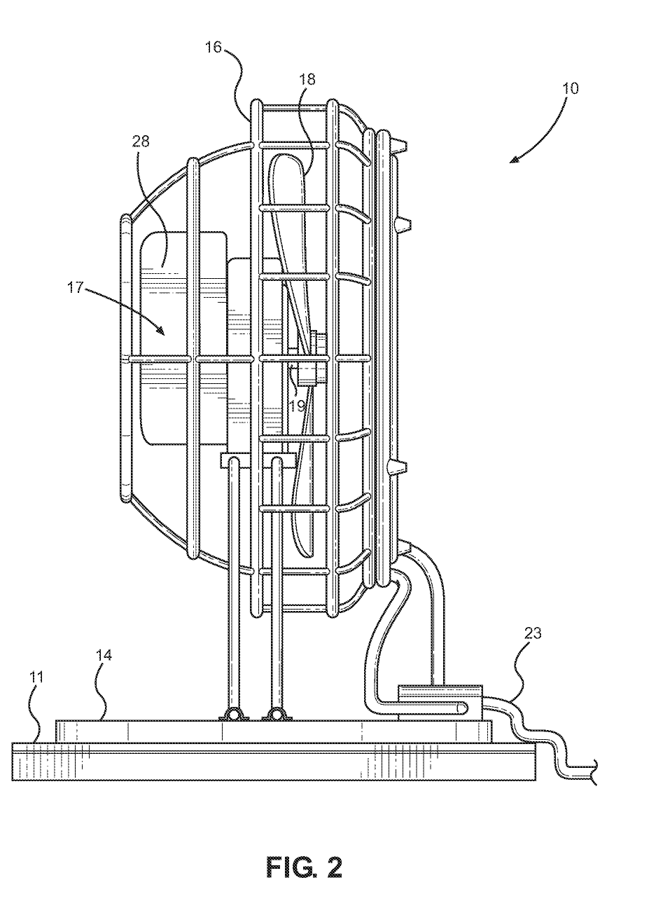

Referring now to FIGS. 1 and 2, there are shown perspective and side views of an embodiment of the water spraying fan. The water spraying fan 10 comprises a base 11 having a rotatable surface 14 disposed thereon. A fan mechanism 17 is secured to the rotatable surface 14, wherein the fan mechanism 17 comprises a plurality of fan blades 18 connected to a power source via a rotating shaft 19. In some embodiments, the fan mechanism 17 is secured to the rotatable surface 14 via one or more support legs 15. In further embodiments, the power source is a motor 28 mounted directly to the water spraying fan 10, while in alternate embodiments, the power source is external, such as a vehicle motor. For example, the water spraying fan 10 may be operably attached to the power take off shaft of a vehicle. Alternatively, the motor 28 may comprise an internal combustion engine, such as an eight cylinder V8 gasoline engine, directly connected to the rotating shaft 19.

A cage 16 is disposed around the plurality of fan blades 18, where the cage 16 has a circular manifold 24 attached to a front side thereof. The circular manifold 24 comprises a length of tubing arranged in a circular shape having a plurality of nozzles 25 disposed along a front side thereof, positioned away from the plurality of fan blades 18. The circular manifold 24 is operably connected to a flow control box 20 via a connecting tube 23.

The flow control box 20 includes an inlet 21 configured to operable connect to a water source 21. The flow control box 20 includes a valve adapted to adjust the flow of water between a fully stopped position and a fully open position. In some embodiments of the water spraying fan 10, the valve may additionally set the flow rate of water at an intermediate position.

In some embodiments of the water spraying fan 10, a second circular manifold 26 is secured to the cage 16 adjacent and concentric to the circular manifold 24. The second circular manifold 26 likewise comprises a second plurality of nozzles 27 positioned in the same direction as the plurality of nozzles 25. Both circular manifolds 24 and 26 are configured such that their respective nozzles 25, 27 comprise a diameter that is less than a diameter of the plurality of fan blades 18, ensuring that any water sprayed from the nozzles is directly in the stream of air created by the rotation of the plurality of fan blades 18. This dual configuration allows a user to use fewer nozzles while maintaining a desired flow rate, enabling the water to spray at a desired distance while reduced the volume of water used, if not necessary for a particular application. For example, each manifold 24, 26 may comprise three evenly spaced nozzles 25, 27, where a user may decide to either have the water directed toward all six nozzles 25, 27 or only three nozzles 25 or 27. In some embodiments of the water spraying fan 10, the nozzles 25, 27 further comprise a mechanism configured to adjust the pattern of water spray. For example, a collar disposed on each nozzle may be rotated in one direction to concentrate the spray in a tight stream, and may be rotated in an opposing direction to spread the spray, resulting in a fine mist.

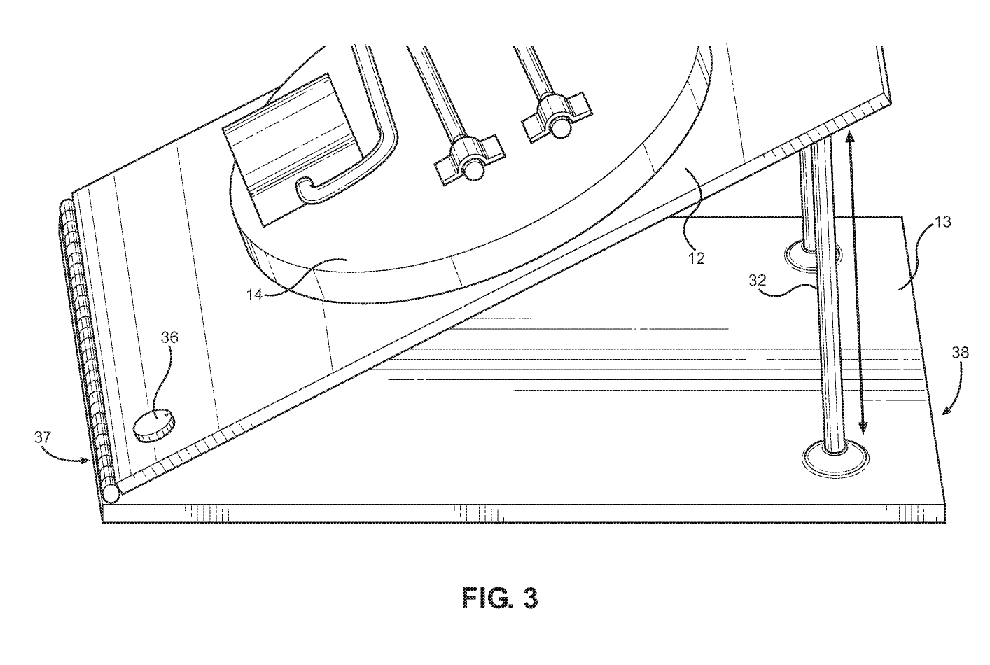

Referring now to FIG. 3, there is shown a close up view of the tilting mechanism of an alternative embodiment of the water spraying fan. In some embodiments of the water spraying fan 10, the base further comprises a top member 12 that is hingedly attached to a bottom member 13 at a first end 37 thereof. A tilt mechanism is configured to adjust the angle of the top member 12 relative to the bottom member 13. Additionally, the rotatable surface 14 may be adjusted in tandem with the tilt mechanism to allow a user to direct the water flow from the water spraying fan 10 to a specific target.

In some embodiments of the water spraying fan 10, the tilt mechanism comprises one or more telescopic arms 32 secured to the bottom member 13 and a second end thereof 38 that are configured to raise the top member 12, thus tilting the water spraying fan 10 at an angle. The telescoping arms 32 of the tilting mechanism may be actuated using a variety of methods, such as hydraulic power or a rack and pinion gear.

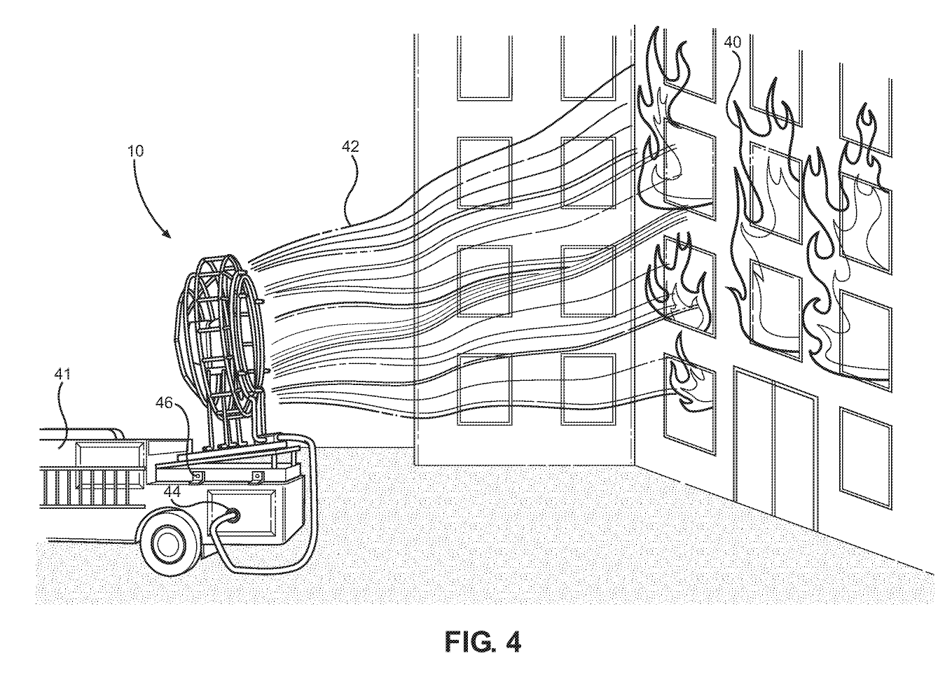

Referring now to FIG. 4, there is shown a perspective view of the water spraying fan in use. The water spraying fan 10 may be used freestanding or mounted onto a vehicle, such as a fire engine 41. Additionally, the water source that is operably connected to the flow control box may be a reservoir 44 on a vehicle 41, allowing full mobility when using the water spraying fan 10.

In operation, the water spraying fan 10 is placed on the ground or mounted onto the vehicle 41 using fasteners 46. The flow control box is connected to a water source 44, and the direction of the manifold and plurality of fan blades is pointed toward a desired location, such as a building 40. When the flow control box is activated, water flows through manifold and out the plurality of nozzles. The power source rotates the fan blades, creating a strong air flow current. The pressure of the water from the nozzles coupled with the strong air flow current carries the water across an extended distance and toward the desired destination.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A water spraying fan, comprising:
a base having a rotatable surface disposed thereon;
a fan mechanism mounted to the rotatable surface, the fan mechanism comprising a plurality of fan blades connected to a power source via a rotating shaft;
a cage enclosing the plurality of fan blades, the cage having a circular manifold secured to a front side thereof, where the circular manifold comprises a plurality of nozzles configured to disperse a liquid in front of the plurality of fan blades, and where the plurality of nozzles is concentric to the rotating shaft;
wherein the circular manifold is in fluid communication with a flow control box comprising an inlet configured to operably connect to a water source, where the flow control box is configured to control the level of the flow rate of water to the plurality of nozzles.

2. The water spraying fan of claim 1, wherein the circular manifold comprises a diameter that is less than a diameter of the plurality of fan blades

3. The water spraying fan of claim 1, further comprising a secondary circular manifold that is secured to the cage adjacent to and concentric with the circular manifold, wherein the second circular manifold comprises a second plurality of nozzles configured to disperse liquid in front of the plurality of fan blades.

4. The water spraying fan of claim 3, wherein flow control box is configured to control the flow rate of water to the second circular manifold,

5. The water spraying fan of claim 1, wherein the base comprises a first end and a second end, and further comprises a top panel hingedly attached to a bottom panel at the first end thereof.

6. The water spraying fan of claim 5, wherein the base further comprises a tilt mechanism configured to adjust the angle of the top panel relative to the bottom panel.

7. The water spraying fan of claim 6, wherein the tilt mechanism comprises a telescopic arm on the second end of the base, such that when telescopic arms are extended, the second end of the top panel separates from second end of the bottom panel.

8. The water spraying fan of claim 7, where the telescopic arms are controlled via a hydraulic system.

9. The water spraying fan of claim 1, wherein the power source is a gasoline engine.

10. The water spraying fan of claim 1, wherein power source is a power take off from a vehicle.

11. The water spraying fan of claim 1, wherein the base is configured to be securely fastened to a vehicle.

12. The water spraying fan of claim 1, wherein the flow control box and circular manifold are further configured to operably connect to a fire resistant foam propellant source.
